(19) United States
(12) Patent Application Publication
(10) Pub. No.: US 2023/0191704 A1
(43) Pub. Date: Jun. 22, 2023

(54) GENERATION OF A PROTECTIVE STRUCTURE FOR A 3D PRINTED OBJECT

(71) Applicant: Hewlett-Packard Development Company, L.P., Spring, TX (US)

(72) Inventors: Davinia Font Calafell, Sant Cugat del Valles (ES); Alex Carruesco Llorens, Sant Cugat del Valles (ES)

(21) Appl. No.: 17/996,051

(22) PCT Filed: Apr. 30, 2020
(86) PCT No.: PCT/US2020/030642

§ 371 Date: Oct. 12, 2022

(51) Int. Cl. B29C 64/393; B29C 64/182; B29C 64/153

(52) U.S. Cl. CPC B29C 64/393; B29C 64/182; B29C 64/153; B33Y 50/02

(57) ABSTRACT

Object model data is obtained, defining an object to be built by a three-dimensional printing apparatus. Data defining a protective structure to be built around the object by the three-dimensional printing apparatus is automatically generated. Different portions of the protective structure each have a structure defined by a respective structural parameter that determines the thermal properties of the portion, and each respective structural parameter is determined based on the object model data so as to provide a selected level of heat dissipation through the respective portion of the protective structure, when the object and protective structure are built by the three-dimensional printing apparatus.

### BACKGROUND

Some additive manufacturing systems, such as powder fusing and powder sintering systems, raise the temperature of a powdered build material to promote fusing or sintering or other bonding. A powdered build material may comprise spheres, granules, pellets, fibres, platelets, particles of irregular shape, hollow particles, and combinations thereof, which can be joined together to form desired objects. In a three-dimensional (3D) printing apparatus that uses raised temperatures during printing, a build operation is followed by cooling of the built objects.

Built objects may be removed from the printing apparatus for cooling, to enable the printing apparatus to be used for other printing jobs while objects are cooling. Printed objects may be cooled within a build unit of a 3D printing apparatus or may be removed from the build unit to complete their cooling. Some 3D printing systems include a build unit that is a removable component of a printing system, so that a build process may be followed by removal of the build unit to a place where it will be cooled. To avoid such movements of build units or removal of objects from a build unit damaging the built objects while they are in a structurally vulnerable state, i.e. when not yet fully cooled, a protective structure forming a surrounding cage or envelope may be built around a printed object or around a set of objects as part of the 3D printing process. The protective structure protects the built objects during cooling, for example by maintaining stability for some layers of unfused build material around fused build material.

### BRIEF DESCRIPTION OF THE DRAWINGS

Apparatus, methods and computer program products are described below, by way of example, with reference to the accompanying drawings in which:

FIG. 1 shows schematically an example configuration of a protective build envelope;

FIG. 2 shows an example method for generating data defining a protective structure;

FIG. 3 shows an example of a layer of a print job;

FIG. 4 shows an example method for generating and printing an object and protective structure;

FIG. 5 shows an example of a computer readable medium comprising instructions to generate data defining a protective structure; and

FIG. 6 shows components of an example printer control architecture.

### DETAILED DESCRIPTION

In some additive manufacturing processes, a fusing agent may be used to fuse together particles of a thin layer of build material formed on a build platform to form a layer of a solid object or part.

A layer of build material may be formed by a manufacturing machine having a roller or spreader that spreads the powder to thereby provide successive layers on a build platform. A print nozzle may then jet fusing agent at precise locations on to the powder bed to define the geometry of the single or multiple parts to be printed. An energy emitter may be used to cause those portions of powder on which fusing agent was applied to heat up above the melting point of the powder, which may cause the powder particles in those portions to melt and coalesce together. This process may be repeated until the part or parts are formed layer by layer.

By analysing a two-dimensional image of a layer of a three-dimensional print job to be printed, a processor of the additive manufacturing system processes the three-dimensional print job and determines print instructions indicating precisely when fusing agent is to be deposited on the print layer, for example as a carriage including the print nozzle moves over the layer of build material. This determination may be completed on a layer by layer basis before each layer is jetted with agent.

Additive manufacturing based on a three-dimensional computer model of an object is often referred to as 3D printing, and the phrases “additive manufacturing” and “3D printing” are used interchangeably in this patent specification.

One example 3D printing technique is selective laser sintering, in which selected parts of a layer of build material are sintered by the heating effect of a targeted laser beam. Another example 3D printing technique uses energy absorbing fusing agents for highly-localised control of the amount of energy from a radiation source which is absorbed by a build material, to control the temperature of selected parts of a layer of build material according to the presence of a fusing agent which promotes heat absorption and therefore fusing at selected locations. One example technique using a fusing agent is known as high speed sintering. In some fusing techniques, a detailing agent which has a cooling effect may also be used to inhibit fusing at chosen locations adjacent to the desired fusing. The example solution described in detail below is suitable for 3D printing techniques including these localised fusing and sintering examples, but the term “fusing” which is used below for ease of reference is intended to include other additive manufacturing techniques that involve heating a powder.

In some 3D printers, an object or a plurality of separate objects may be built by selectively heating, melting and fusing powder particles of a layer of build material on a fabrication bed in a build chamber. The chamber is part of a build unit that is connected to a printing unit which controls the build operation. After the completion of the build operation, the build unit containing the object may be disconnected from the printing unit for cooling, and this may involve connecting the disconnected build unit to an external cooling system. Alternatively, a build unit may be left to cool naturally. To allow the build unit to be available for other build operations, it may be desirable for the built objects to be removed from the build chamber before cooling is complete. In systems using thermal fusing of build material, the built objects may be vulnerable to distortions until they have been cooled below a safe temperature, so there may be a delay before built objects are cool enough to be safely extracted from the build chamber, and there may be a consequent delay before a build unit is connectable back to the printing unit to start a new printing process. The cooling of the contents of the build chamber, i.e. a printed object or objects and unfused build material, may take a considerable amount of time depending on the size of the build chamber.

To enable extraction of built objects from the build chamber before cooling is completed following the printing process, a protective structure may be printed around the built objects during the printing of those objects. The protective structure may be any configuration that provides a degree of protection to the contained objects, e.g. a closed container that fully encapsulates the objects or an open lattice structure that helps to reduce movement of the contained build material and consequently reduces distortion of the built objects. The protective structure may be referred to as a protective “build envelope” or “cage” or “transfer box”, for example, to aid visualization of some potential configurations. The term “transfer box” is intended to refer to any configuration of protective structure that may protect built objects during transfer to a location at which cooling will take pace. The protective structure protects the built objects until they have cooled sufficiently, in particular avoiding damage in examples that allow early extraction when the built objects are in a structurally vulnerable state, while also retaining a structure of the protective build envelope and unfused powder around the built objects, which allows the thermal stability of the printed job to be controlled. The thermal properties of the built objects will depend on the particular print job, e.g. the size and arrangement of built objects within the build volume. In particular, where certain regions of the build volume include a large amount of fused build material, the heat generated during printing may be higher than in other regions.

The described method allows the protective build envelope to be generated in such a way that different portions of the envelope have different thermal characteristics, depending on the objects to be built and their arrangement within the build volume. In this way, the envelope may be arranged to facilitate a higher rate of heat dissipation, during cooling, from regions of the build volume in which more heat is generated during printing. In some examples it may be possible to provide more uniform cooling across the print job, thereby improving thermal stability and resulting in improved part quality. The build envelope may also be generated so as to further control the overall rate of heart dissipation from the build volume, at the same time as facilitating different rates of heat dissipation from different regions. In this way, it may be possible to control the overall rate of cooling of the build volume, which may in turn control the overall part quality, while maintaining thermal stability and uniformity of cooling across the print job.

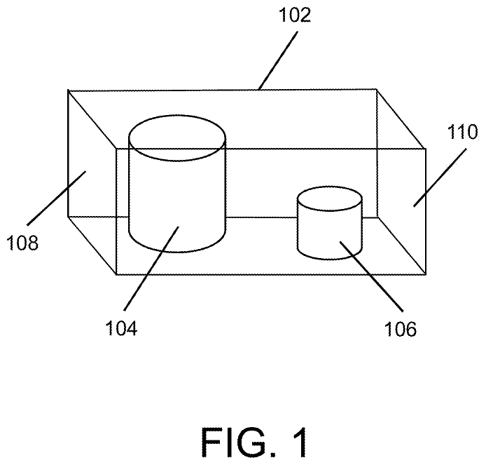

FIG. 1 shows schematically a set of objects 104, 106 to be built by a 3D printer, where the objects are enclosed by a protective envelope 102. In this example, the envelope comprises a cuboid with sides or faces located at the periphery of the build volume, and the objects comprise two objects of differing sizes. It can be seen that one of the faces 108 of the envelope is adjacent a larger of the objects 104, and an opposite face 110 is adjacent a smaller object 106. It will be appreciated that there is a larger concentration of fused build material in the region of the build volume adjacent to face 108 than in the region adjacent to face 110, since a larger volume of build material is used to form the larger object 104 than is used to form the smaller object 106. Accordingly, more heat is generated during printing in the vicinity of face 108 than in the vicinity of face 110. In accordance with the method described in more detail below, faces 108 and 110 may be provided with different structural properties, for example wall thicknesses, that provide the faces with different thermal properties in order to adapt the level of heat dissipation through the respective faces during cooling of the printed objects. In this way, the print job can be arranged such that, when the objects 104, 106 and the protective envelope 102 are generated by the 3D printer, a higher level of heat dissipation is provided through face 108 than through face 110, in order to extract heat more quickly from the region of object 104 than from the region of object 106. This may provide more uniform cooling across the print job.

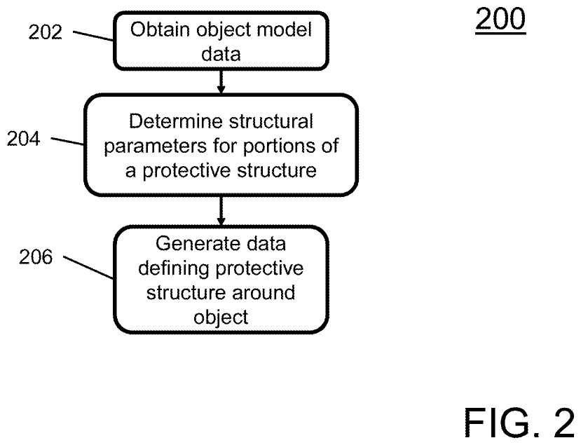

FIG. 2 shows an example process for generating data defining a protective structure or envelope to be built around an object. In this example, object model data is obtained at 202. The object model data represents the object or objects to be generated by the 3D printer, and may be generated in a pre-print application outside of the 3D printer, or alternatively may be generated within the printer.

At 204, structural parameters are determined for different portions of a protective envelope to be built around the object(s), where the structural parameters each define a structure of a respective portion of the envelope, and determine the thermal properties of that portion. For example, the structural parameter may represent a wall thickness of a portion of the envelope, which determines the level of heat dissipation through that portion of the envelope when the object(s) and envelope are built by the 3D printer. The structural parameters are determined based on the object model data. For example, a structural parameter for a portion of the envelope may be determined on the basis of the proportion of build material to be printed, compared with the total volume of build material, in a region of the build volume corresponding to, e.g. adjacent to, the respective envelope portion. This example is described in more detail below.

At 206, data defining the protective structure or envelope around the object(s) is generated, based on the determined structural parameters of the different portions of the envelope, and the object(s) and envelope may then be built by the 3D printer. The printing may take place immediately, or at some later time. The protective envelope may be generated as a 3D model of the envelope and combined with the model of the object(s) to be printed, or alternatively the data defining the protective structure may be generated for each layer of a print job, and combined with the data representing that layer of the object(s), in order to produce print instructions for the printer to generate the respective layer of both the object(s) and the protective structure.

The determination of the structural parameters on the basis of the object model data may be combined with existing methods for generating a protective structure around the object(s), such that a protective structure is generated in accordance with an existing method and then the structural parameters are modified for different portions of the protective structure in order to adjust the level of heat dissipation through different portions of the envelope when the object(s) and envelope are built. Where the print job includes a plurality of objects, the structural parameters of different portions of the envelope may be determined in such a way as to provide different heat dissipation characteristics at portions of the protective structure in the vicinity of different respective objects, based on the model data of the respective objects.

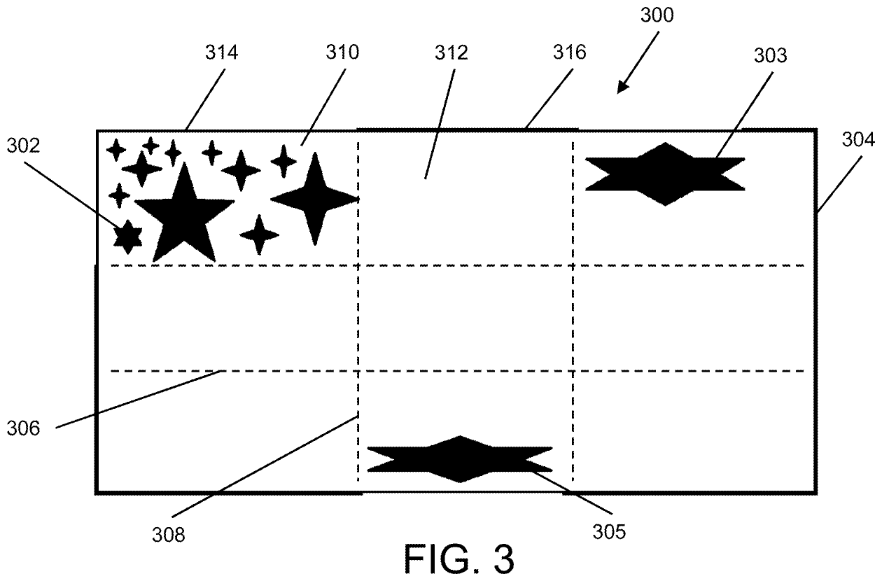

FIG. 3 shows an example of a layer 300 of a print job, which effectively corresponds to a cross section through the objects to be printed and the surrounding protective structure. In this example, the layer 300 includes sections of a plurality of objects, of which those designated 302, 303 and 305 are examples. The objects are surrounded by a section of a protective envelope 304, which in this example comprises of a continuous perimeter wall extending around the periphery of this layer of the build volume. In the layer of this example, it can be seen that the objects to be printed are not evenly distributed throughout the layer, and that in some regions there is a concentration of small objects, e.g. in the vicinity of objects 302, other regions contain a single larger object, e.g. object 303, and in other regions there are no objects to be printed in the layer. As a result, in regions where more build material is to be printed, i.e. where there is a higher proportion of the total build material to be printed in a given area, more heat may be generated during the printing of that layer in those regions than in regions where a smaller proportion of the build material is to be printed.

In accordance with the described method, the structure of different portions of the protective envelope may be varied to alter the thermal properties of these portions, so as to provide different levels of heat dissipation through different portions of the protective envelope during cooling of the completed print job, to allow for different amounts of heat generated in different regions of the build volume, and thereby increase the thermal uniformity of the build.

The structural parameter may be any parameter of the structure of the protective envelope which influences the thermal characteristics of a portion of the envelope, for example the thickness of a wall of the envelope in that portion. A thinner wall will allow a higher rate of heat extraction through that portion of the wall, whereas a thicker wall will provide a lower rate of heat extraction. Other structural parameters that influence the heat dissipation through the envelope portion may be used, instead of the wall thickness. For example, walls of the envelope may have a mesh or grid structure, in which the ratio of solid material to spaces is varied to alter the thermal properties. Alternatively, or in addition, walls of the envelope may not vary in thickness but may instead vary in the amount of solid material printed between the inner and outer surfaces of the wall. In another example, walls of the envelope may have other structures in which the ratio of solid to unfused material is varied to alter the thermal properties of the wall. The envelope structure and thermal properties may be varied in any way which allows control of the cooling in different regions of the build volume, e.g. by varying the thermal conductivity or resistivity of portions of the envelope to alter the rate of heat dissipation from respective regions of the printed objects and surrounding unfused material during cooling.

In one example, a portion of the protective envelope for which a structural parameter is defined may be the portion of the envelope located in a given layer of the build volume. In this example, the portion has the height of a build layer, and the structural parameter is determined for each layer of the print job. In a further example, this portion may be further subdivided into different portions within the layer, i.e. different areas around the perimeter of the layer, and the structural parameter determined for each of these sub-portions within the layer, as described further in connection with FIG. 3.

In the example of FIG. 3, a layer of a print job is shown in which different regions of the layer include different proportions of the build material in that region being printed in order to build the objects. As a result, when printing the illustrated layer during the printing of the entire build volume, more heat may be generated in some regions of the layer than in others. In accordance with the described method, the wall thickness of the protective envelope 304 is varied for different portions of the envelope within the layer 300 in dependence on the proportion of build material to be printed in an adjacent region of the layer. In this way, different levels of heat dissipation may be provided for different regions, depending on the amount of heat which will be generated in that region during printing.

In this example, the layer 300 is shown subdivided into a plurality of different zones, in this case illustrated by grid lines 306, 308 dividing the layer into nine zones, for ease of illustration. It will be appreciated that the layer may be divided into zones or regions in different ways, and may be divided into any number of zones which may be equal or differing sizes and/or shapes. In another example, a layer may have a printable area in the region of 380×284 mm in x and y axes respectively, and the layer may be divided into zones of approximately 50×50 mm, resulting in a grid of approximately 8×6 zones.

In the example of FIG. 3, it can be seen that one of the zones 310 includes a relatively large cross-sectional area of objects, and hence a relatively large proportion of the build material to be printed in that region, whereas an adjacent zone 312 includes no build material to be printed within the layer 300. Accordingly, more heat may be generated in zone 310 than in zone 312 during printing of the layer. As a result, when generating the protective envelope 304 for this layer, the envelope is provided with a thinner wall in the vicinity of zone 310 than in the vicinity of zone 312. In particular, a portion 314 of the envelope 304 which is adjacent to zone 310 is set to a smaller wall thickness than a portion 316 of the envelope adjacent to zone 312. By varying the wall thickness of the envelope in this way, a selected level of heat dissipation is provided through different wall portions of the protective envelope, when the objects and protective structure are built by the 3D printer. In one example, the wall thickness may be determined based on the proportion of build material to be printed within a respective region of the build volume, relative to the total volume of build material in that region, but in other examples the wall thickness may be determined on the basis of the proportion of build material to be printed within more than one region, for example in an immediately adjacent region and one or more other nearby regions. Furthermore, in other examples, other parameters of the object model data may be used as indications of the heat to be generated, and hence a selected level of heat dissipation, for a particular region of the build volume, for example by taking into account not only the volume of build material to be printed within a region, but also their proximity to the respective portion of the protective envelope and/or their distribution within the region.

Also, in the example shown in FIG. 3, the wall thickness is used as a structural parameter which is varied to provide different portions of the protective envelope with different thermal characteristics, but in other examples alternative structural parameters of the envelope may be varied, as described above.

By altering the wall thickness, and hence the thermal characteristics, of the protective envelope as shown in FIG. 3, regions having a thinner envelope wall allow a greater rate of heat diffusion towards the outside of the printing bed during cooling, which may contribute to a more uniform thermal footprint across the build volume. This may give rise to a more stable and uniform annealing process in the print job, and consequently a better dimensional accuracy in the printed objects.

The structural parameter for a given portion of the envelope may be set within a predetermined range of values. For example, where the structural parameter is a wall thickness of the envelope portion, the wall thickness may be determined in accordance with the following formula:

wt=wtₘᵢₙ*d+wtₘₐₓ*(1−d) (1)

where wt is the of the thickness wall portion; wtₘᵢₙ is a predetermined minimum thickness; wtₘₐₓ is a predetermined maximum thickness; and d is a printing density coefficient. The printing density coefficient is, in this example, set at a value between 0 and 1, and is indicative of the proportion of build material to be printed in a respective region of the build volume. For example, the printing density coefficient may be set as a proportion of build material to be printed in the respective region of the build volume, where a value of 0 corresponds to 0% of the build material in the region being printed, and a value of 1 corresponds to 100% of the build material in the region being printed. The value may vary linearly between 0 and 1 in proportion to the percentage of build material to be printed, or alternatively other non-linear functions may be used.

This formula ensures that the specified wall thickness of a given portion of the envelope is always within the configured limits, and the thickness may be increased to the maximum value for portions of the envelope corresponding to, e.g. adjacent to, regions of the build volume having no printed content (or a low amount of printed content), while the thickness may be reduced to the minimum value for portions of the envelope corresponding to regions of the build volume having a high ratio of printed to non-printed content. It should be noted that the values of wtₘᵢₙ and wtₘₐₓ may be set differently for different build materials, because different materials exhibit different physical properties may which affect the structural integrity of the build envelope.

As described above with reference to FIG. 3, the printing density coefficient used to set the wall thickness of a given portion of the envelope may be determined in respect of a region immediately adjacent to the given envelope portion, or may be based on more than one region, for example an immediately adjacent region and another nearby region or regions. In the layer 300 shown in FIG. 3, the printing density coefficient may be determined for the entire layer and used to set the wall thickness for the entire envelope 304 within that layer, or may be determined for each individual zone, e.g. zones 310 and 312, and used to set the wall thicknesses for individual respective wall portions, e.g. respective wall portions 314 and 316.

Furthermore, other parameters indicative of likely heat generation within a given region of the build volume during subsequent printing may be determined from the object model data. Such parameters may be used in place of, or in addition to, the determination of the proportion of build material to be printed in the region, in order to generate a different measure of a suitable level of heat dissipation from the printed envelope structure. Accordingly, a different coefficient, which may also be set at a value between 0 and 1, may be used in place of the printing density coefficient d in equation (1), to set the wall thickness or other structural parameter of the envelope portion. Alternatively to, or in addition to, the use of the printing density coefficient to determine the structural parameter, the structural parameter may be determined or adjusted using real-time feedback from the printer during the printing process. For example, the temperature of the print bed may be measured during printing, e.g. using a thermal camera, and the measured temperature may be used to determine or adjust the structural parameter. In one example, the print bed temperature may be measured for a given layer during printing, and the wall thickness or other structural parameter of the protective structure determined, or adjusted from a previously determined value, on the basis of the measured temperature for that layer, or for regions within the layer.

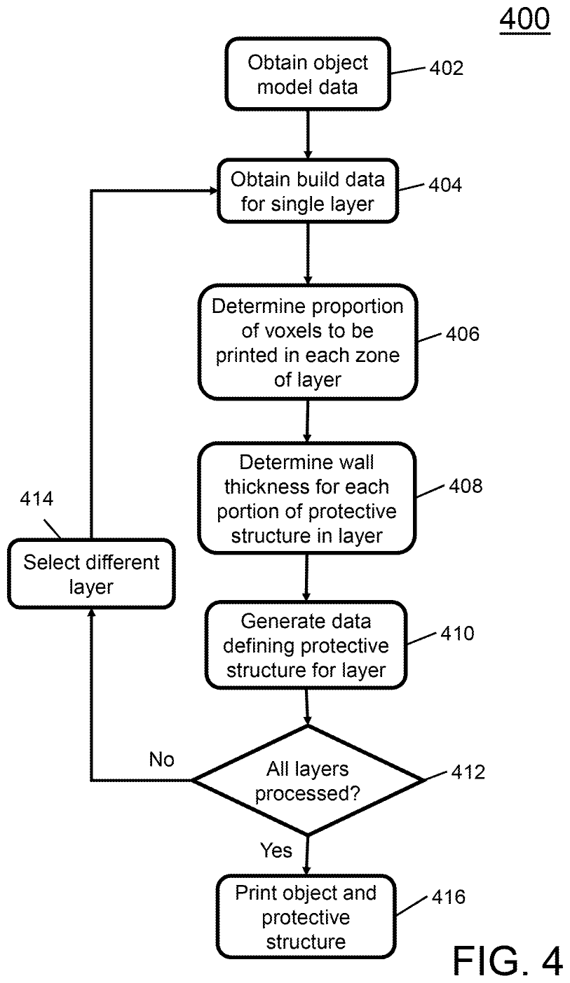

Referring now to FIG. 4, a further example method for generating and printing an object and protective structure is shown. In this example, object model data is obtained at 402, which may be the same or similar object model data as referred to above in connection with FIG. 2. At 404, build data is obtained for a single layer of the print job. This build data may, for example, comprise a layer image used by the 3D printer to print an individual layer of the build volume. In this example, the layer is divided into a plurality of zones, and the layer may be a layer of the type illustrated in FIG. 3. Using the layer data obtained at 404, for each zone within the layer the proportion of build material to be printed is determined, relative to the total volume of build material in the zone, at 406. These determined proportions each reflect the concentration of build material to be printed within the zone, and may therefore give an indication of the heat to be generated in that region during printing of the layer. On the basis of these determined proportions, a wall thickness is determined at 408 for each portion of a protective structure within the layer, where the wall thickness of an envelope portion may be determined on the basis of the proportion of build material to be printed in a zone immediately adjacent to that portion of the envelope. The wall thickness may be determined using equation (1) described above.

At 410, data is generated defining the protective structure for the layer, on the basis of the determined wall thicknesses for each portion of the protective structure. At 412, it is determined whether all layers of the object model have been processed. If not all layers have been processed, then a different layer is selected at 414 and the method continues from 404 by processing this different layer of the object model to determine the wall thicknesses and generate data defining the protective structure for that layer. If it is determined at 412 that all layers of the object model have been processed, such that data defining the entire protective structure around the object(s) to be printed has been generated, then in this example, the object model and protective structure are printed at 416. The printing process then generates the object(s) together with the determined protective structure. The protective structure may provide a selected level of heat dissipation through respective portions of the protective structure, one the printed object(s) and protective structure have been separated from the build unit, and any build material surrounding the protective structure has been removed.

In the described methods, the data defining the protective structure may be generated automatically on the basis of the object model data, and this method may be carried out once a print job including the object model data has been sent to a 3D printer for printing. The method may further include generating printer control data comprising instructions to control a 3D printing apparatus to build the object and the protective structure around the object. In other examples, the protective structure may be generated in a pre-print application, and a user may have the opportunity to approve or modify the protective structure before printing. The protective structure may be generated in a region at the periphery of the build volume, outside the normal user-definable printing volume, such that the envelope may be generated without encroaching on the three-dimensional model data provided by a user to a 3D printing apparatus.

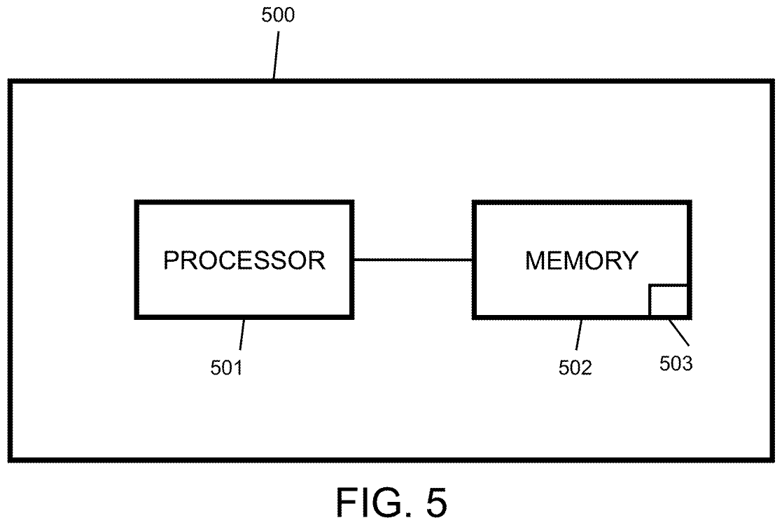

FIG. 5 shows an example of a controller 500 to generate data defining a protective structure. The controller 500 comprises a processor 501 and a memory 502. Stored within the memory 502 are instructions 503 for generating data defining a protective structure according to any of the examples described above. In one example, the controller 500 may be part of a computer running the instructions 503 as part of an application program remote from an additive manufacturing system that can build objects in accordance with the model data. In another example, the controller 500 may be part of a 3D printer able to run the instructions 503 after providing object model data to the printer.

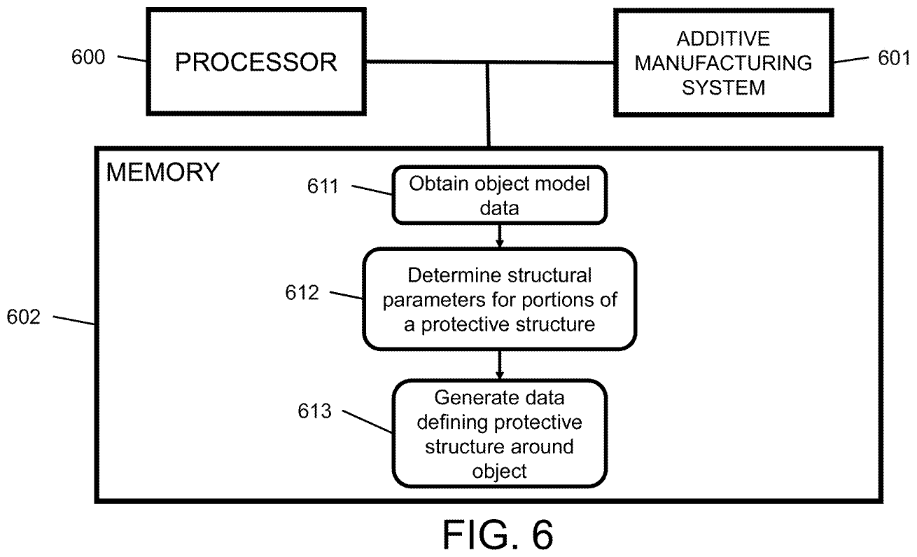

FIG. 6 shows an example control architecture for a 3D printer. A 3D printer, or additive manufacturing system 601 is provided with a processor 600 for executing control instructions saved in a memory 602. Memory 602 is an example of a computer readable medium storing instructions 611, 612, 613 that, when executed by the processor 600 communicably coupled to the 3D printer 601, cause the processor 600 to generate data defining a protective structure in accordance with any of the examples described above. The computer readable medium 602 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
obtaining object model data defining an object to be built by a three-dimensional printing apparatus; and
automatically generating data defining a protective structure to be built around the object by the three-dimensional printing apparatus, different portions of the protective structure each having a structure defined by a respective structural parameter that determines the thermal properties of the portion, the method comprising determining each respective structural parameter based on the object model data so as to provide a selected level of heat dissipation through the respective portion of the protective structure, when the object and protective structure are built by the three-dimensional printing apparatus.

2. The method of claim 1, comprising determining the structural parameter of each portion of the protective structure based on the proportion of build material to be printed within a respective region of a build volume when the object is built by the three-dimensional printing apparatus.

3. The method of claim 1, wherein the protective structure comprises one or more walls and the structural parameter comprises the thickness of a portion of a wall.

4. The method of claim 3, comprising reducing the thickness of the wall portion with increasing proportion of build material to be printed in a respective region of the build volume.

5. The method of claim 3, comprising determining the thickness of the wall portion by:
wt=wtₘᵢₙ*d+wtₘₐₓ*(1−d)
where wt is the wall portion thickness; wtₘᵢₙ is a predetermined minimum thickness; wtₘₐₓ is a predetermined maximum thickness; and d is a printing density coefficient between 0 and 1, indicative of the proportion of build material to be printed in the respective region of the build volume.

6. The method of claim 5, comprising setting the printing density coefficient d as a proportion of build material to be printed in the respective region of the build volume, from 0, corresponding to none of the build material being printed, to 1, corresponding to 100% of the build material being printed.

7. The method of claim 2, comprising determining the structural parameter for a layer of the build volume based on the proportion of build material to be printed in the layer.

8. The method of claim 7, comprising dividing the layer into a plurality of zones, and determining the structural parameter of a portion of the protective structure in the layer based on the proportion of build material to be printed in a respective zone within the layer.

9. The method of claim 8, wherein the respective zone is a zone adjacent to the portion of the protective structure.

10. The method of claim 1, wherein the object model data defines a plurality of objects, and the structural parameters of different portions are determined so as to provide different heat dissipation characteristics at portions of the protective structure in the vicinity of different objects, based on the model data of the respective objects.

11. The method of claim 1, further comprising: generating printer control data comprising instructions to control a three-dimensional printing apparatus to build the object and to build the protective structure around the object.

12. The method of claim 11, comprising executing the generated printer control data on a three-dimensional printing apparatus to control the apparatus to build the object and the protective structure.

13. The method of claim 1, comprising measuring the temperature of build material during building of the object and protective structure by the three-dimensional printing apparatus, and adjusting the structural parameter based on the measured temperature.

14. A system comprising:
a controller configured to:
obtain object model data defining an object to be generated by an additive manufacturing system; and
generate data defining a protective structure to be built around the object by the additive manufacturing system, wherein portions of the protective structure each have a structure defined by a respective structural parameter that determines the thermal properties of the portion, wherein each respective structural parameter is determined based on the object model data so as to provide a selected dissipation of heat through the respective portion of the protective structure, when the object and protective structure are built by the additive manufacturing system.

15. A computer-readable medium comprising instructions that, when executed by a processor communicably coupled to an additive manufacturing system, cause the processor to:
obtain object model data defining an object to be generated by the additive manufacturing system; and
generate data defining a protective structure to be generated around the object by the additive manufacturing system, wherein respective portions of the protective structure each have a structure defined by a corresponding structural parameter that determines thermal characteristics of the portion, wherein each respective structural parameter is determined based on the object model data so as to provide a selected dissipation of heat through the respective portion of the protective structure, when the object and protective structure are generated by the additive manufacturing system.
